(19) United States
(12) Patent Application Publication
(10) Pub. No.: US 2019/0318319 A1
(43) Pub. Date: Oct. 17, 2019

(54) System for Contracting Equipment and Personnel via a Mobile Device Application

(71) Applicant: Magnum Blackburn, Kaneohe, HI (US)

(72) Inventor: Magnum Blackburn, Kaneohe, HI (US)

(21) Appl. No.: 16/432,628

(22) Filed: Jun. 5, 2019

Related U.S. Application Data
(60) Provisional application No. 62/653,352, filed on Apr. 5, 2018.

(51) Int. Cl. G06Q 10/10; G06F 16/23; G06F 16/2457; G06F 3/0482

(52) U.S. Cl. CPC G06Q 10/1053; G06F 3/0482; G06F 16/24575; G06F 16/2379

(57) ABSTRACT

A software system, enacted via a mobile device application and website, provides for a system and method for hiring of video capture, image capture, and/or live-stream capture services to be provided by a freelance user associated with the system. Consumer users hire freelance users, both members of the system, to provide capture services in accordance with the desired geographic position, angle, and physical placement of the capture. Mobile capture, in the form of live-streaming capture, may be specified by the consumer user such that footage occurs over a range of locations. Payment and review of services is accomplished via the mobile application. Other contracted services may be facilitated via the mobile device application, ranging from real estate purchase based on capture footage, to VR/AR playback of capture, food truck on-demand service, and power of attorney transmission.

### CONTINUITY

This application is a non-provisional application of provisional patent application No. 62/653,352, filed on Apr. 5, 2018, and priority is claimed thereto.

### FIELD OF THE PRESENT INVENTION

The present invention relates to the field of virtual presence, and more specifically relates to a system by which a user may hire an individual to act on behalf of the user at a specified location to take photos, capture video recordings, provide a live stream video, and/or provide other services for the user in exchange for a fee.

### BACKGROUND OF THE PRESENT INVENTION

There are several reasons why an individual may be unable or unwilling to make it in-person to an event, meeting, convention, expo, or similar occasion held at a specific location. Generally, if an individual is unable to make it to a live event, he or she is relegated to read about it in the news, view press photos, and/or watch officially sponsored live video footage. While this helps the user gather information about what he or she missed at the event or on-site location, it lacks a personal touch. The user has no input as to where, or from what angle the photos or video are captured. If there were a way in which a user could easily hire an individual to capture footage and/or images from positions of his or her choosing at a specified location, the user could enjoy personalized content tailored to the desires of the user.

While it is presently possible to hire a photographer or videographer for a specific event, (or indeed, for any extraneous reason) the cost is often quite high. As such, the common person is unable to afford a proxy for most events, or even to simply take photos on behalf of the user in a different location. In the case of real estate evaluation, users are known to review online listings, which often include pictures and occasionally videos of a property which may or may not include captures of the interior of the property. However, these pictures and videos are often old, and do not present an accurate portrayal of the property in real-time. As such, users interested in the property conventionally visit the property in person to obtain such data in real-time. This can be very time consuming, especially if the party/user interested in the property does not live near by, or even in the same country. If there were a way that a user (such as an interested party) could view current, or livestream footage of an event or location via the hiring of a contractor via a mobile device application, time and money would be saved, while other individuals may be easily employed anywhere in the world.

Similarly, if there were a way in which a user could hire at least one individual to perform any given service, remotely in his or her stead, via a computer application, the desires of the user could be enacted remotely in exchange for a feat, facilitated via the computer application.

Thus, there is a need for a system and method by which a user may hire an individual for a service, such as freelance photographer, videographer, or live-streamer for a given occasion, event, or to simply capture a desired location for assorted purposes, including real estate rental, real estate purchase, real estate sale, fish-finding (such as with an underwater camera), movie creation, hiring a private detective for surveillance, live weather update, etc. Contractors compete to provide on-demand services per their equipment availability. A user could be contracted to provide access to his or her laptop computer, either for processing power or livestreaming footage. Similarly, a user could be contracted to check out what fish are near a specific pier by performing a brief underwater dive at the location, and relaying footage and/or text description of the fish availability at the specified location. Likewise, such a system could be employed to contract a user to provide computer services via the remote loaning of his or her computer for an assortment of purposes, including the augmentation of computing power, such as for the purposes of hosting or cryptocurrency mining.

### SUMMARY OF THE PRESENT INVENTION

This Summary of the Invention is provided to introduce a selection of concepts in a simplified form that are further described below in the Detailed Description. This Summary is not intended to identify key features or essential features of the claimed subject matter, nor is it intended to be used to limit the scope of the claimed subject matter.

The present invention is mobile device application, embodying a system and method by which a user may select, contract, and hire one or more individuals to perform a service, such as capture media on behalf of the user at a specified location, or to contract other services based on equipment the contractor has on-hand. Via the mobile device application (preferably additionally accessible via a website), users may peruse a variety of freelance photographers and/or videographers to be hired for specific purposes. Users available for hire may specify a specific geographical location in which they are available for work. If numerous users are requesting to hire a contractor within a specific location at a similar time, prices for services within the specific area may increase in accordance with a surge pricing model.

Upon selection of a freelance user (a contractor) of the system via the mobile device application per a map feature, the user then selects the type of work (images, video, livestreaming footage, AR/VR, or other remote service) desired. The time and date of the desired media capture is indicated. The freelance user has the option to accept or reject the job. Upon acceptance of the job via the application of the present invention, the freelance user performs the hired task at the specified location, and relays the files and/or live-streaming link to the first user per the work request. Users may preferably provide ratings of each other according to work performed, and timely payment.

Such a system is useful for businesses, such as those having a real estate business, for the capture of images of a house, business building, or other structure. Users may select freelance users for hire based on their expertise, ratings of prior work made by other users, and equipment. For example, if a user has a need for drone footage of a specified location, he/she would hire a freelance user experienced in drone footage capture, and who owns a drone. Similarly, if a user has a need for 4k video capture, he/she would select a freelance user who owns a 4K video camera. If a user has a desire to find out if there are fish present and biting nearby, he/she can contract a user to go find out, and report back with footage of the fish, or text relating to the fishing conditions at the specified location. It should be understood that freelance users are contractors to be employed by users of the system and application of the present invention.

A variety of other service-based concepts may be facilitated via the system of the present invention, including, but not limited to: temporary land rental (such as for farming/agriculture or RV camping), viewing randomized livestreams (from other customers) amounting to a form of “livestream radio,” 3D printing services (hiring a contractor to craft an item via 3D printing on behalf of the customer), and other rental mechanisms.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts a view of the preferred embodiment of the mobile device application of the present invention, depicting the contractor selection screen.

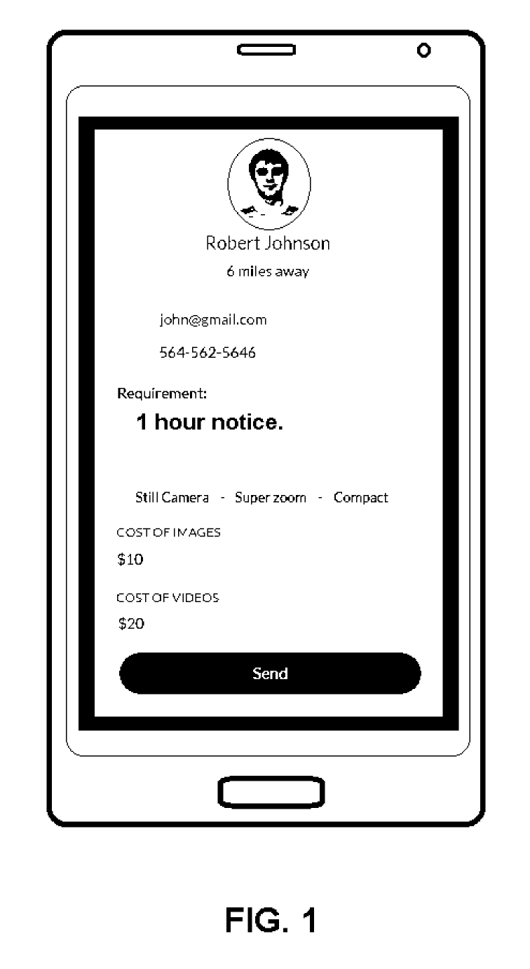

FIG. 2 exhibits a flow-chart detailing the process of use of the present invention.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is a system and method for the conscription of services relating to image capture, video capture, and livestream video capture. Other services can also be conscribed, including computer sharing, via the mobile device application of the present invention.

The mobile device application of the present invention exhibits a map for the selection of a location at which a contractor may be hired to perform services. An assortment of contractors are displayed on the map, or depicted in a list format. The user may then select the desired contractor for the services needed, and then proceeds to select the desired equipment to be used for the service. Equipment to be selected is based on the user profile of the contractor, from which he/she preferably lists out the type of cameras, computers, or recording devices he or she is willing to use on behalf of other users (in the case of photography/videography/VR/AR/Livestreaming contracting), or to which remote access may be provided to the user (such as remotely accessing a computer). Equipment options are also preferably shown to the user, which can include lenses, tripods, boom microphones, 360 degree cameras, drone-mounted cameras, thermal cameras, underwater cameras, 4k cameras, Polaroid™ or instant-print cameras, and other conventional equipment. Other accessories are also preferably available, including gimbals, interchangeable lenses, point-and-shoot cameras, zoom lenses, 3D scanners, 3D printers, water proof cameras, and other conventional accessory options.

Similarly, it should be understood that the system and method of the present invention may be used to facilitate the contracting of other services, including formal rentals of space and/or land. For example, a user may employ the platform of the present invention to arrange to pay for the use of a parcel of land for temporary agricultural purposes, and even contract a contractor to work the land in his/her stead. In such cases, the contractor would grow crops in accordance with the wishes and specifications of the user, including what crop(s) to grow. Likewise, a user may arrange for the temporary use of the space and/or land of a contractor, ranging from a rental of a drawer to a parking spot. Agricultural land sharing via the contracting system of the present invention may be used to facilitate the storage of livestock on another's land (the contractor's) for a fee. Similarly, the sharing of a room, office, or whole house may be facilitated via the system of the present invention.

Other service reservations may also be made via the system of the present invention. For example, a user may hire a contractor via the service to arrange for a marching band to play at a specific location and time. It is envisioned that, in the event of a queue or a ‘wait’ for a given contractor's services, a futures market could be implemented which enables payment upon service completion (meeting the terms of the contract established via the software/platform). In some of these usage scenarios, additional options and security features are implemented. For example, contractors are provided the option to execute a background check, and may enforce restrictions, such as “no weapons allowed” in the rental of a campsite on the contractor's private property. Contractors may similarly sublet WiFi service at a given location of a contractor's business or residence. Other instances of use of the system and method of the present invention include, but are not limited to, the contracting of robotic equipment which may facilitate control of the robotic system via the software of the present invention. For example, the user may control a robot, owned by the contractor, and indicate a predetermined path (route) for the robot to follow while capturing video or performing other automated tasks. Ride sharing may also be incorporated as a service within the system and software of the present invention.

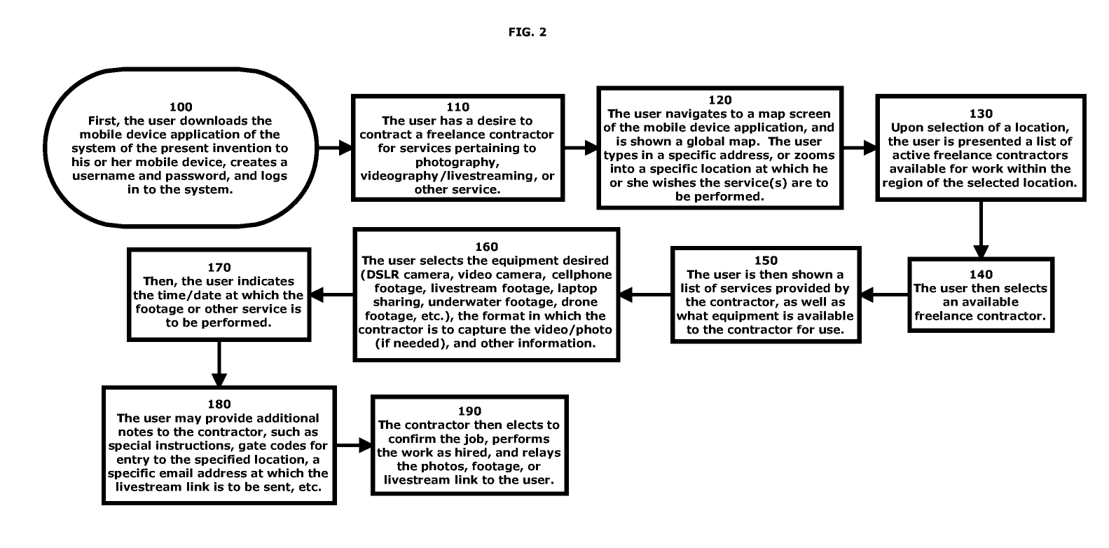

The method of use of the system of the present invention by a user hiring a contractor, as depicted in FIG. 2, is preferably as follows:

1. First, the user downloads the mobile device application of the system of the present invention to his or her mobile device, creates a username and password (creating a user account), and logs in to the system. (100) If he or she does not yet have an account, the user creates an account with a username and password via the mobile device application.
2. The user has a desire to contract a freelance contractor for services pertaining to photography, videography/livestreaming, or other service. (110)
3. The user navigates to a map screen of the mobile device application, and is shown a global map. The user types in a specific address, or zooms into a specific location at which he or she wishes the service(s) are to be performed. (120) A pin may be dropped by the user on the map to indicate the location.
4. Upon selection of a location, the user is presented a list of active freelance contractors available for work within the region of the selected location. (130)
5. The user then selects an available freelance contractor. (140) The user selects the contractor by tapping on the contractor's username and/or photo.
6. The user is then shown a list of services provided by the contractor, as well as what equipment is available to the contractor for use. (150)
7. The user selects the equipment desired (DSLR camera, video camera, cellphone footage, livestream footage, laptop sharing, underwater footage, drone footage, etc.), the format in which the contractor is to capture the video/photo (if needed), and other information. (160) Users may also specify if ‘extras’ are to be used, such as boom microphones, 360 view cameras, body mics, etc.
8. Then, the user indicates the time/date at which the footage or other service is to be performed. (170) Price shown may be determined in part by the demand at the time and/or location selected by the user. The user may also potentially negotiate pricing with the contractor via a messaging feature of the mobile device application.
9. The user may provide additional notes to the contractor, such as special instructions, gate codes for entry to the specified location, a specific email address at which the livestream link is to be sent, etc. (180) If photography services are contracted, such as for private eye services, the user may opt to have photos physically printed and delivered to the user here.
10. The contractor then elects to confirm the job, performs the work as hired, and relays the photos, footage, or livestream link to the user. (190) If another service, such as a computer share service was contracted, the contractor then provides access links to the user per their agreement.

It should be understood that the system of the present invention may be used to contract the services of businesses as well. For example, if X amount of users declare a desire for a specific food truck at a specific location, and have agreed to prepay for food, then the food truck driver may opt to take the order, and travel to the indicated location. Similar, a scuba diving company may be available for contracted dives. For example, if a user has a desire to know if fish are present at a specific site, such as for fishing or viewing, he can hire a contractor to scuba dive at the specified site and relay footage of the dive (or text-based information) to the user for a fee.

Similarly, it should be understood that the reasoning for the contracting of photographic services need not be specific. For example, if a user has a need to incorporate 3D scans of objects and places in the real world (such as for mapping or game development), he or she can use the system of the present invention to contract services of a user to take photos/scans of such elements for entering into his/her AR/VR game or other system as a virtual object. Likewise, it should be understood that captures obtained by contracted users of the system of the present invention may employ the footage to facilitate the creation of VR/AR elements, further facilitating the viewing of properties/locations when not physically at the locations—or, in the case of AR, providing additional information about the specific location/property via an AR viewer.

Some embodiments of the mobile device application of the present invention may be configured to capture an image of the user during the contractor hiring process for security purposes. In such instances, the mobile device application employs the onboard camera(s) of the mobile device to capture and save at least one photo of the user.

Additionally, it is envisioned that users may employ the system of the present invention to hire a contractor for the purposes of a live weather update system. For example, a user planning to drive on a specific mountain road in the winter can find out if the route is passable if he or she notices a contractor near or on the road in question. The user can hire the contractor to look outside and/or drive on the road to report road or weather conditions in real-time to the user via the mobile device application of the present invention.

Some embodiments of the mobile device application of the present invention preferably include a feature which allows for one or more administrators of the system of the present invention to communicate with all users and contractors of the system via a messaging system.

Likewise, some embodiments of the present invention may be configured to employ the Near Field Communication (NFC) radio disposed with the mobile devices of the contractor and/or user of the present invention to facilitate payment, marketing purposes, or other service-based duties. An NFC based token may be employed to verify to users that the correct contractor has shown up to the location hired, or that the correct contractor is relaying the footage/images to prevent spam or impersonation.

Additional alternate embodiments of the present invention may include the use of A.I. or robotic cameras which may be contracted for a location or event on-demand via the application of the present invention. In some embodiments, the user may control the robot remotely via the mobile device application of the present invention, helping to ensure the user achieves the shot or angle of the image capture or livestream capture desired.

It should be understood that the present invention may be employed in Augmented Reality (AR) applications. In such instances, AR data may be interlaced or shown atop the livestream footage displayed to the user, and may also be present when the footage or captures are viewed via Virtual Reality (VR).

It is envisioned that multiple services employing the system of the present invention may eventually arise, creating a competitive market. At such time, the system of the present invention may employ an aggregation of livestreaming contractors across multiple services so that users may perform a metasearch across multiple services to discover and hire contractors for the best price.

Other embodiments preferably include a ‘power of attorney request’ feature, which can enable the hired contractor to function as an agent of the user. With such granted permissions, it is envisioned that the contractor may be hired via the mobile device application of the present invention to deliver precious metals, or to pick up precious metals on behalf of the user, and deliver them to the user. For example, a user could hire a contractor to deliver, or facilitate the purchase of gold, silver, or other precious metals to be delivered to the user. The power of attorney feature of such embodiments helps to ensure reliable contracting, and facilitates trust between the contractor and the user. It also allows the contractor to conduct certain business on behalf of the user.

Similarly, some embodiments of the present invention may be configured to facilitate the sharing of office spaces and/or housing, which may be ordered on-demand via the mobile device application of the present invention. Other services, such as contract crafting services by lawyers or law experts could also be requested via the mobile device application of the present invention. Contracts, such as those used to purchase a vehicle or real estate could be facilitated in this manner via the mobile device application of the present invention. A link may be provided via the mobile device application of the present invention to facilitate purchase (by the user) of the real estate shown via VR or other capture by the contractor. Other embodiments of the present invention may facilitate real estate rehabbing, or the repair of a property for the intent of purchase/sale. In such embodiments, users may hire a contractor for simple services relating to the property depicted in the capture, such as basic painting, which is also subject to a contract agreement facilitated via the mobile device application of the present invention.

Additionally, some embodiments of the present invention may enable the linking of a brain-wave detector to facilitate mental manipulation of footage playback, movement within a VR environment depicting the footage/captures, and other UI manipulation.

Embodiments of the present invention are also preferably equipped with tourism features, such as VR ghost tours, which can be enacted on behalf of the user by a contractor. Users can opt to view a prior VR tourism experience, such as a ghost tour of a ‘haunted’ town, or to hire a contractor to capture livestreaming footage of such a ghost tour (or similar tourism experience) to watch in real-time via VR. In such instances, the tourism experience is captured via one or more VR cameras operated by the contractor on behalf of the user.

An additional potential feature of some embodiments of the present invention include a livestreaming wallpaper option which enables a user to view contracted livestream footage on his or her background of a computer or mobile device.

It should also be understood that many features of the present invention are available via a website, and need not be accessed via the mobile device application of the present invention.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A method for offering and contracting services by a user via a computer application comprising:
navigating to the computer application;
creating a username and password attributed to the user;
the application saving the username and password of the user as a user account on a secured server computer;
the user logging in;
the application presenting a map screen to the user via a display of the computer;
the user inputting a specific location into the application;
the application indicating the selected location with a pin placed on the map screen;
the application presenting a list of available contractors for the selected location to the user;
the user selecting an available freelance contractor for at least one service from the list of available contractors;
the application displaying a list of services made available by the selected freelance contractor to the user;
the user selecting an available service from the list of services;
the application displaying a list of equipment pertaining to the selected service which is available from the selected freelance contractor;
the user selecting desired equipment from the list of equipment to be used in the execution of the selected service;
the application prompting the user to specify a time and date at which the service is to be performed;
the user entering the time and date the selected service is needed to the application;
the application displaying an estimated cost of the selected service from the selected freelance contractor with the selected equipment;
the application providing a text entry field for additional notes from the user pertaining to the selected service;
the application prompting the user to confirm the contracting of the contractor to perform the selected service, creating a contract request;
the application conveying the contract request to the selected freelance contractor;
the selected freelance contractor electing to confirm the contract request via the application; and
the selected freelance contractor executing the terms of the contract.
the selected freelance contractor
